(19) United States
(12) Patent Application Publication
(10) Pub. No.: US 2026/0006522 A1
(43) Pub. Date: Jan. 1, 2026

(54) TRIGGER SWITCHING OF MOBILITY SETTINGS

(71) Applicant: Nokia Technologies Oy, Espoo (FI)

(72) Inventors: Dimitri GOLD, Espoo (FI); Lars DALSGAARD, Oulu (FI); Sofonias HAILU, Oulu (FI); Niko KOLEHMAINEN, Jorvas (FI); Rafael CAUDURO DIAS DE PAIVA, Aalborg (DK); Anthony LO, Bristol (GB)

(21) Appl. No.: 19/116,411

(22) PCT Filed: Sep. 30, 2022
(86) PCT No.: PCT/EP2022/077293

§ 371 Date: Mar. 28, 2025

(51) Int. Cl. H04W 36/32; H04B 7/06; H04B 17/318; H04W 36/00

(52) U.S. Cl. CPC H04W 36/324; H04B 7/06952; H04B 17/328; H04W 36/0072

(57) ABSTRACT

Techniques of operating a network include enabling switching between two (or more) mobility settings and optimize those depending on network configuration or UE conditions.

### TECHNICAL FIELD

This description relates to telecommunications systems.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's LTE upgrade path for mobile networks. In LTE, base stations or access points (APs), which are referred to as enhanced Node AP (eNBs), provide wireless access within a coverage area or cell. In LTE, mobile devices, or mobile stations are referred to as user equipment (UE). LTE has included a number of improvements or developments.

A global bandwidth shortage facing wireless carriers has motivated the consideration of the underutilized millimeter wave (mmWave) frequency spectrum for future broadband cellular communication networks, for example. mmWave (or extremely high frequency) may, for example, include the frequency range between 30 and 300 gigahertz (GHz). Radio waves in this band may, for example, have wavelengths from ten to one millimeters, giving it the name millimeter band or millimeter wave. The amount of wireless data will likely significantly increase in the coming years. Various techniques have been used in attempt to address this challenge including obtaining more spectrum, having smaller cell sizes, and using improved technologies enabling more bits/s/Hz. One element that may be used to obtain more spectrum is to move to higher frequencies, e.g., above 6 GHz. For fifth generation wireless systems (5G), an access architecture for deployment of cellular radio equipment employing mmWave radio spectrum has been proposed. Other example spectrums may also be used, such as cmWave radio spectrum (e.g., 3-30 GHz).

### SUMMARY

According to an example implementation, a method includes obtaining, by a user device in a wireless network, one or more mobility settings and one or more conditions which, when triggered, require a switch between mobility settings; receiving, by the user device, an indication that a condition has been triggered; and in response to receiving the indication, switching, by the user device, from a first mobility setting of the one or more mobility settings to a second mobility setting of the one or more mobility settings.

According to an example implementation, an apparatus includes at least one processor and at least one memory including computer program code, the at least one memory and the computer program code configured to, with the at least one processor, cause the apparatus at least to obtain, by a user device in a wireless network, one or more mobility settings and one or more conditions which, when triggered, require a switch between mobility settings; receive, by the user device, an indication that a condition has been triggered; and in response to receiving the indication, switch, by the user device, from a first mobility setting of the one or more mobility settings to a second mobility setting of the one or more mobility settings.

According to an example implementation, an apparatus includes means for obtaining, by a user device in a wireless network, one or more mobility settings and one or more conditions which, when triggered, require a switch between mobility settings; receiving, by the user device, an indication that a condition has been triggered; and in response to receiving the indication, switching, by the user device, from a first mobility setting of the one or more mobility settings to a second mobility setting of the one or more mobility settings.

According to an example implementation, a computer program product includes a computer-readable storage medium and storing executable code that, when executed by at least one data processing apparatus, is configured to cause the at least one data processing apparatus to obtain, by a user device in a wireless network, one or more mobility settings and one or more conditions which, when triggered, require a switch between mobility settings; receive, by the user device, an indication that a condition has been triggered; and in response to receiving the indication, switch, by the user device, from a first mobility setting of the one or more mobility settings to a second mobility setting of the one or more mobility settings.

According to an example implementation, a method includes transmitting, by a network node in a wireless network to a user device in the wireless network, one or more mobility settings and one or more conditions which, when triggered, require the user device to switch between mobility settings; transmitting, by the network node to the user device, an indication that a condition has been triggered; and receiving, by the network node from the user device, an indication that the user device has switched from a first mobility setting of the one or more mobility settings to a second mobility setting of the one or more mobility settings.

According to an example implementation, an apparatus includes at least one processor and at least one memory including computer program code, the at least one memory and the computer program code configured to, with the at least one processor, cause the apparatus at least to transmit, by a network node in a wireless network to a user device in the wireless network, one or more mobility settings and one or more conditions which, when triggered, require the user device to switch between mobility settings; transmit, by the network node to the user device, an indication that a condition has been triggered; and receive, by the network node from the user device, an indication that the user device has switched from a first mobility setting of the one or more mobility settings to a second mobility setting of the one or more mobility settings.

According to an example implementation, an apparatus includes means for transmitting, by a network node in a wireless network to a user device in the wireless network, one or more mobility settings and one or more conditions which, when triggered, require the user device to switch between mobility settings; transmitting, by the network node to the user device, an indication that a condition has been triggered; and receiving, by the network node from the user device, an indication that the user device has switched from a first mobility setting of the one or more mobility settings to a second mobility setting of the one or more mobility settings.

According to an example implementation, a computer program product includes a computer-readable storage medium and storing executable code that, when executed by at least one data processing apparatus, is configured to transmit, by a network node in a wireless network to a user device in the wireless network, one or more mobility settings and one or more conditions which, when triggered, require the user device to switch between mobility settings; transmit, by the network node to the user device, an indication that a condition has been triggered; and receive, by the network node from the user device, an indication that the user device has switched from a first mobility setting of the one or more mobility settings to a second mobility setting of the one or more mobility settings.

The details of one or more examples of implementations are set forth in the accompanying drawings and the description below. Other features will be apparent from the description and drawings, and from the claims.

### BRIEF DESCRIPTION OF THE DRAWINGS

FIG. 1 is a block diagram of a digital communications network according to an example implementation.

FIG. 2 is a diagram illustrating a unidirectional deployment in which the UE is traveling in a direction with the serving beam orientation and the RRH is 10 m from the pathway, according to an example implementation.

FIG. 3 is a diagram illustrating a unidirectional deployment in which the UE is traveling in a direction opposite the serving beam orientation and the RRH is 150 m from the pathway, according to an example implementation.

FIG. 4 is a diagram illustrating a unidirectional deployment in which the UE is traveling in a direction opposite the serving beam orientation and the RRH is 10 m from the pathway, according to an example implementation.

FIG. 5A is a diagram illustrating a bi-directional deployment in which the RRH is 150 m from the pathway, according to an example implementation.

FIG. 5B is a diagram illustrating a RSRP trace corresponding to the bi-directional deployment in FIG. 5A, according to an example implementation.

FIG. 5C is a diagram illustrating a serving RRH index, according to an example implementation.

FIG. 6 is a diagram illustrating a bi-directional deployment in which the RRH is 10 m from the pathway, according to an example implementation.

FIG. 7 is a diagram illustrating a handover issue in a high-speed train, high-frequency (FR2) scenario, according to an example implementation.

FIG. 8 is a diagram illustrating a beam switching issue in a high-speed train, high-frequency (FR2) scenario, according to an example implementation.

FIG. 9 is a flow chart illustrating an improved process of handling mobility settings, according to an example implementation.

FIG. 10 is a flow chart illustrating different alternatives for triggering conditions in between different mobility settings, according to an example implementation.

FIG. 11 is a diagram illustrating multiple mobility settings configured in a high-speed train, high-frequency (FR2) scenario, according to an example implementation.

FIG. 12 is a flow chart illustrating a mobility setting and parameter optimization algorithm, according to an example implementation.

FIG. 13 is a sequence diagram illustrating a scenario with two mobility settings, according to an example implementation.

FIG. 14A is a plot of RSRP traces of serving and best target beams for a default mobility setting, with RRH location shown, according to an example implementation.

FIG. 14B is a plot of RSRP traces of serving and best target beams for two mobility settings, with RRH location shown, according to an example implementation.

FIG. 15 is a plot illustrating SINR CDFs collected from a high-speed train, high-frequency (FR2) scenario for default implementation with one mobility setting and for an optimized case with two mobility settings, according to an example implementation.

FIG. 16 is a flow chart illustrating a method for handling multiple mobility settings, according to an example implementation.

FIG. 17 is a flow chart illustrating a method for handling multiple mobility settings, according to an example implementation

FIG. 18 is a block diagram of a node or wireless station (e.g., base station/access point, relay node, or mobile station/user device) according to an example implementation.

### DETAILED DESCRIPTION

The principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

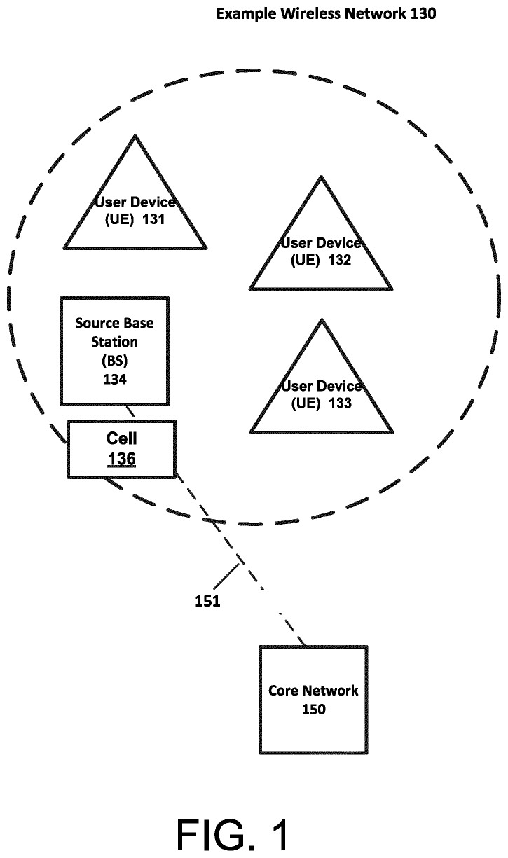

FIG. 1 is a block diagram of a digital communications system such as a wireless network 130 according to an example implementation. In the wireless network 130 of FIG. 1, user devices 131, 132, and 133, which may also be referred to as mobile stations (MSs) or user equipment (UEs), may be connected (and in communication) with a base station (BS) 134, which may also be referred to as an access point (AP), an enhanced Node B (eNB), a gNB (which may be a 5G base station) or a network node. At least part of the functionalities of an access point (AP), base station (BS) or (e) Node B (eNB) may also be carried out by any node, server or host which may be operably coupled to a transceiver, such as a remote radio head. BS (or AP) 134 provides wireless coverage within a cell 136, including the user devices 131, 132 and 133. Although only three user devices are shown as being connected or attached to BS 134, any number of user devices may be provided. BS 134 is also connected to a core network 150 via an interface 151. This is merely one simple example of a wireless network, and others may be used.

A user device (user terminal, user equipment (UE)) may refer to a portable computing device that includes wireless mobile communication devices operating with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, a vehicle, and a multimedia device, as examples. It should be appreciated that a user device may also be a nearly exclusive uplink only device, of which an example is a camera or video camera loading images or video clips to a network.

In LTE (as an example), core network 150 may be referred to as Evolved Packet Core (EPC), which may include a mobility management entity (MME) which may handle or assist with mobility/serving cell change of user devices between BSs, one or more gateways that may forward data and control signals between the BSs and packet data networks or the Internet, and other control functions or blocks.

The various example implementations may be applied to a wide variety of wireless technologies, wireless networks, such as LTE, LTE-A, 5G (New Radio, or NR), cmWave, and/or mmWave band networks, or any other wireless network or use case. LTE, 5G, cmWave and mmWave band networks are provided only as illustrative examples, and the various example implementations may be applied to any wireless technology/wireless network. The various example implementations may also be applied to a variety of different applications, services or use cases, such as, for example, ultra-reliability low latency communications (URLLC), Internet of Things (IoT), time-sensitive communications (TSC), enhanced mobile broadband (eMBB), massive machine type communications (MMTC), vehicle-to-vehicle (V2V), vehicle-to-device, etc. Each of these use cases, or types of UEs, may have its own set of requirements.

3GPP has been working on defining requirements related to User Equipment (UE) behavior in High-Speed Train (HST) scenario when operating at higher frequencies (e.g., frequency range 2, FR2). When operating at higher carrier frequencies it is often necessary (and often understood as being necessary) for either UE or network or both to make use of directional beam steering (beam forming) in order to improve the link budget to ensure larger cell coverage. Applying beam forming (or in general just ‘beams’) introduces directionality of the uplink (UL) and downlink (DL) signals. Hence, the UE has to steer its receiving beam (Rx spatial settings) such that it in best case has maximum reception gain (UE Rx beam is directed towards the gNb Tx beam) while the network has to optimize its DL transmission beam such that it is optimal in terms of directing as much as possible of the transmitted energy towards the UE. Similar applies for the UL link.

In HST scenario, the baseline deployment will make use of a number of cells deployed along the train track. Each cell will consist of one or more Remote Radio Heads (RRHs) (also referred as transmission-reception point (TRP), Access Point (AP) or similar), which are connected to one Distributed Unit (DU) that handles the physical resource scheduling. To optimize the deployment and minimize mobility interruptions, the RRHs of the cell can be non-collocated, i.e., distributed along the railway track. In some HST FR2 scenarios, the Dynamic Point Selection (DPS) transmission scheme is considered, i.e., only one RRH of the cell is transmitting/receiving at a time.

Different Deployment Scenarios were Considered in HST FR2:
1. Uni-directional deployments:
   a. Train travelling direction is the same with the serving beam orientation. In so-called Scenario-A, the distance from the RRH to the track Dmin is 10 m.
   b. Train travelling direction is opposite to the serving beam orientation
      i. RRHs are far from the track (Scenario-B, Dmin=150 m)
      ii. RRHs are close to the track (Scenario-A, Dmin=10 m)
2. Bi-directional deployments
   a. Train is close to the railway track (Scenario-A)
   b. Train is away from the railway track (Scenario-B)

### Uni-Directional:

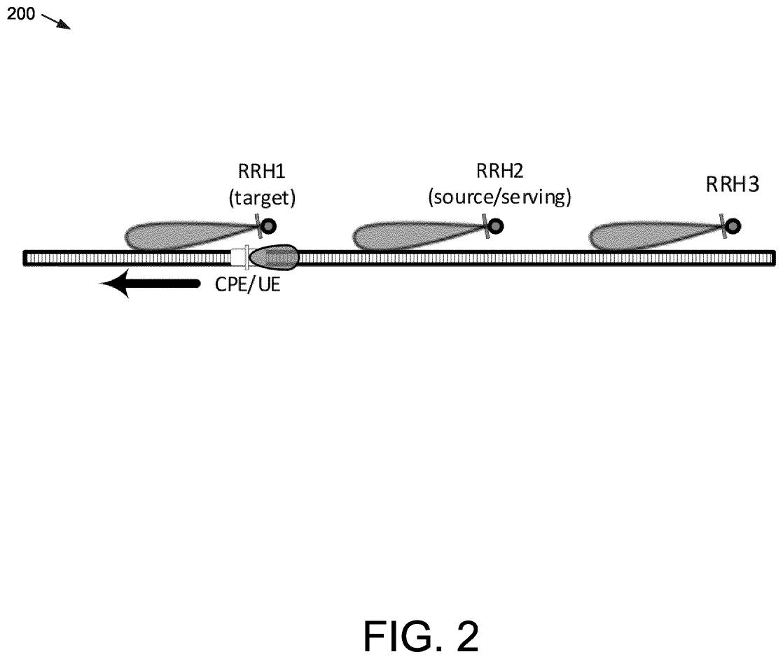

The uni-directional Scenario-A where the train travelling direction is the same with the serving beam orientation (FIG. 2) does not pose mobility problems because serving beams from RRH2 have good coverage over a long distance (considerably above typical inter-RRH distance of 700 m), i.e., the scenario is not coverage limited. The signal from RRH2 is decaying smoothly, and there is enough time for the UE to switch beam/HO to the new beam from RRH1.

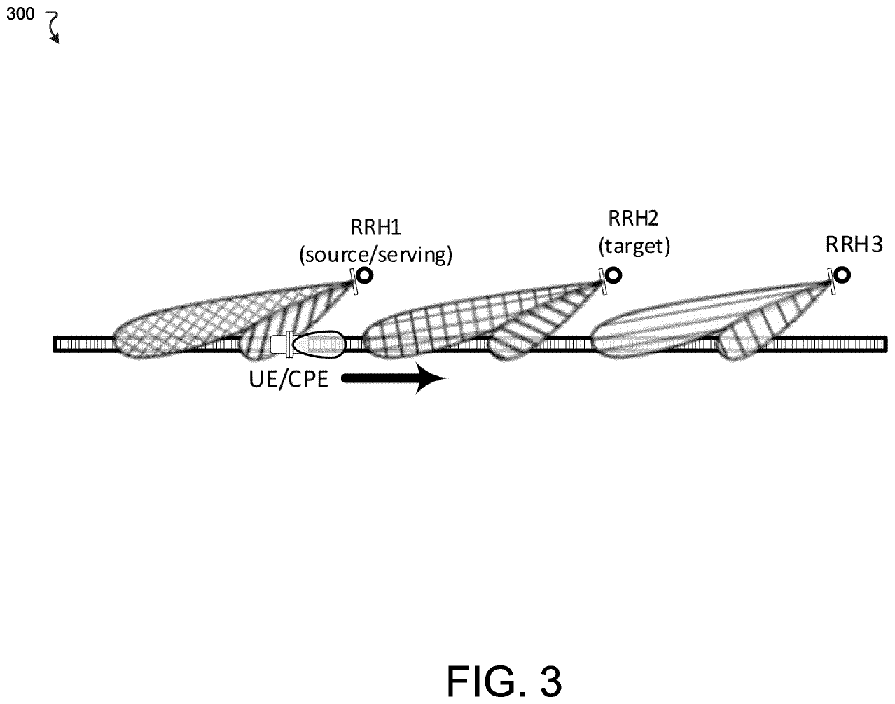

In Scenario-B more than one Tx and Rx beams are beneficial due to a larger distance from the RRH to the track (reference Dmin is 150 m). Scenario-B in FIG. 3 is not that mobility challenging either because the RRH is far away from the track, and, in practice, the beams have side-lobes that make the signal strength decay relatively smooth even when the UE is getting closer to the end of the coverage area of the serving beam of RRH1.

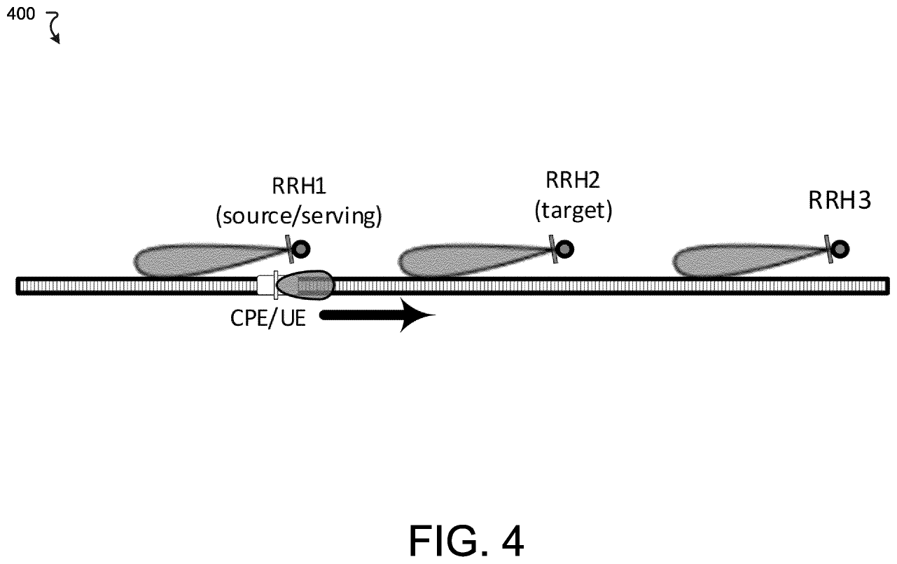

Scenario-A in FIG. 4 is more challenging for mobility because the signal strength of RRH1 is decaying quickly when the UE passes the RRH1. One reason for that is the closeness of the RRH's to the track. Additionally, antenna panels are usually used with a backplane, i.e., the back-lobe that could potentially improve the coverage behind the RRH is attenuated.

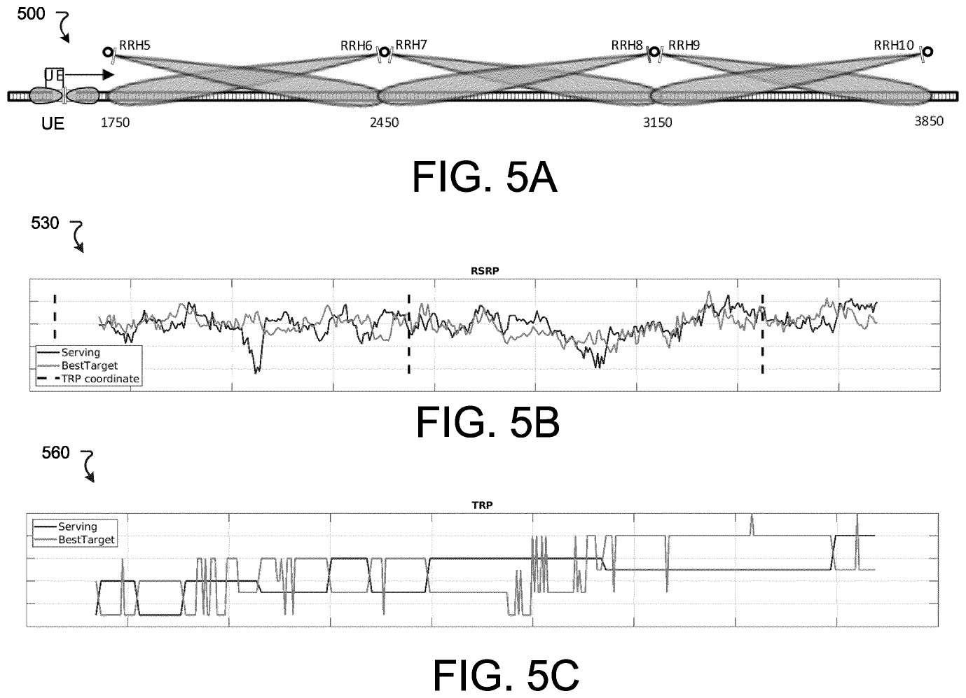

There are several ways to deploy bi-directional Scenario-B (Dmin=150 m). The scheme shown in FIG. 5A is designed in such a way that the UE is served by the next closest RRH. It was proposed to avoid frequent large jumps in propagation delay at RRH changes which are unavoidable completely in practice though. With this scheme, there is no issue with abrupt signal strength degradation. As it is shown in the Reference Signal Received Power (RSRP) trace (FIG. 5B), signal strength goes down in the middle between the RRH where the UE shall change the beam. However, no problem in the signal strength is observed next to the RRH locations due to the beam orientations. FIG. 5C shows the serving RRH index.

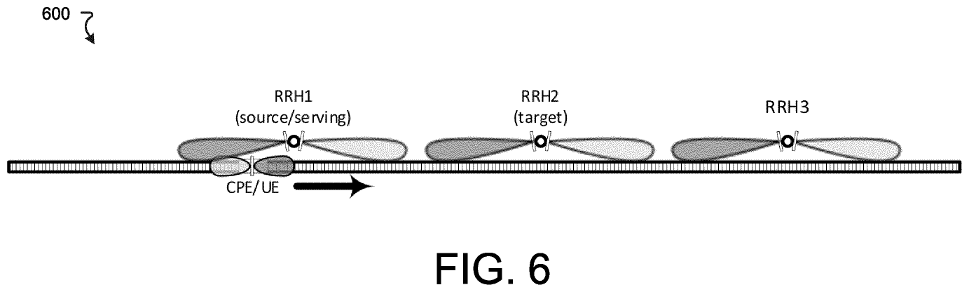

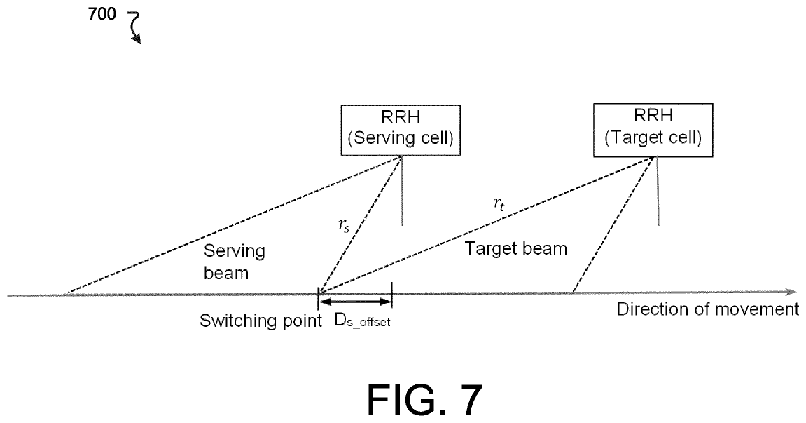

On the other hand, in bi-directional Scenario-A (Dmin=10 m) shown in FIG. 6, the UE beam that is oriented opposite (red) to the serving beam direction (red) experiences the same problems as a UE in uni-directional Scenario-A (FIG. 4).

Change between cells is understood to be done using legacy HO procedure, while the change between the RRHs within the same cell is understood to be handled by beam switches. Beam switching (network controlled) is also referred to as Transmission Configuration Indicator (TCI) state switching in 5G NR. However, in general, it is a change of serving DL beam from a RRH to use a new target DL beam from the same or a different RRH and/or cell.

Mobility between cells in NR, including also FR2 and HST scenario, is done based on UE-assisted measurement reporting and network-controlled HO. UE will measure neighbor cells and based on, e.g., report triggers, the UE will send L3 measurements report to the network. Based on network algorithm, the network will decide if HO to the new target cell is needed. If so, the source cell will negotiate HO with the target cell which provides the source cell with the necessary HO configuration information which the source cell then forwards to UE in the HO command message. Once UE receives the HO command message, the UE will disconnect from the source cell and access the source cell. Until the UE receives the HO command from the source cell the UE will remain connected to the source. Hence, as can be understood the delay of the overall HO procedure is of importance, especially in HST scenario.

Beam switching in NR is also based on UE measurement assistance and network control. However, instead of L3 RRM measurements and reporting the procedure is based on L1 measurements (also sometimes referred to as beam measurements, L1-RSRP measurements etc.). The L1 measurements are reported to the network using L1 measurement reporting. Based on the received L1 measurement report the network can decide (based on network implementation specific algorithm) whether there is a need to request a beam switch, i.e., whether the UE should be switched from using current source beam to using a new target beam. Beam switching is done using TCI state change procedure which is a Medium Access Control (MAC) based procedure. The common understanding is that beam switching procedure is faster than HO procedure.

In a conventional HST FR2 communications scheme, there are several problems.
The signal strength of the serving beam is degrading drastically which may happen for example at the edge of the beam/RRH coverage area, resulting that conventional HO-based mobility (including reporting of measurements and HO signaling) cannot react fast enough and hence does not provide a robust enough solution.
In the wider area, more aggressive generic HO parameters result in the unnecessary increase in the number of mobility events (e.g., HOs, ping-pongs, etc.), i.e., in more frequent interruption of data transmissions.
The same issues as above are typical not only for the HO in between the cells but also for the inter-RRH beam switches, i.e., beam management procedures.
If several settings of mobility parameters are used in the deployment, then it is not obvious when to change from one setting to another and how to select parameters of each of the settings

A potential handover issue arises when the UE is moving in the direction that is opposite to the direction of RRH Tx (transmit) beams as depicted in Error! Reference source not found. A handover can be expected to occur in the handover region or at the switching point D_{s_offset}, which is defined as the optimal point where UE switches from the serving RRH beam to the target RRH beam based on maximizing SNR/RSRP among the detected beams.

It is assumed that a typical Event A3 is used to trigger handover (when the target cell is better than the current serving cell) using a 3 dB offset. In this example it is assumed that network use SSB based RSRP (SS-RSRP) and event A3 for triggering the UE to transmit a UE measurement report to the network. Hence, the event is triggered if the following condition is satisfied.

$$SS - {RSRP}_{t} > SS - {RSRP}_{s} + 3 dB$$

where SS-RSRPₜ is the SS-RSRP of the best SSB beam in the target cell, and SS-RSRPₛ is the SS-RSRP of the current serving SSB beam in the serving cell.

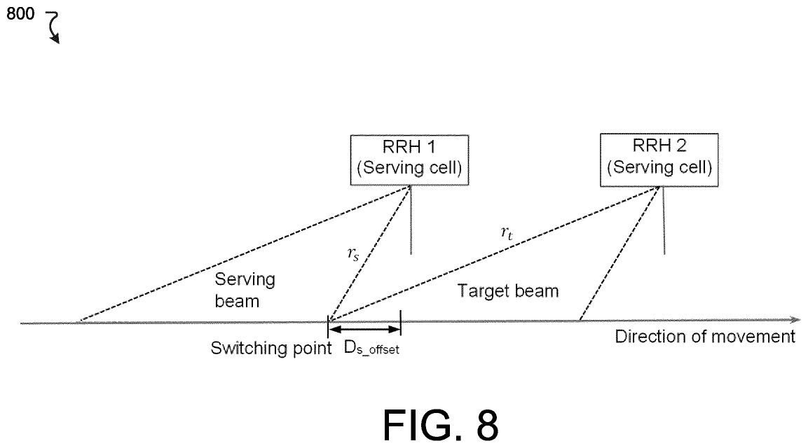

The beam switching issue is in principle similar to the HO issue outlined above. Unlike HO, the target beam belongs to a different RRH in the serving cell as illustrated in FIG. 8. An optimal beam switch shall occur at point Ds_offset, but it is not. This is because the target beam SNR/RSRP is worse than the serving beam as a consequence of large differences in the path loss between the serving beam and the target beam. Thus, no beam switching could occur until beam coverage is lost, resulting in beam failures.

It was demonstrated that HST FR2 Scenario-A deployment (FIG. 4) where the train is travelling in the direction opposite to serving beam orientation may experience mobility challenges. This happens due to the very fast degradation of serving RRH signal.

It has been proposed to use more aggressive HO parameters and/or Conditional HO (CHO) in opposite Scenario-A. However, the problem of such approach is that the signal strength of source and target RRHs is rather close to each other long time before the actual HO/beam switch. Therefore, changing HO parameters in the whole deployment, e.g., increasing the value of the mobility event threshold, will result in the increased number of ping-pongs. Ping-pong is a set of two handovers that happen between two same base stations during one second, i.e., the source of the first handover is the same as the target of the second handover. This negative effect from aggressive HO settings is confirmed with the results of system-level simulations.

In an example, some of the main mobility-related KPIs received from the system-level simulator are shown, such as the ratio of faulty mobility events (top), time of outage (bottom left) and frequency of HOs (bottom right). Two HO settings were considered independently:
Conservative=offset 3 dB, Time To Trigger (TTT) 80 ms; HO: Aggressive=offset 0 dB, TTT 0 ms,
Aggressive HO settings improve failure rate significantly, but also without DRX there are still 4.4% of failures.

More aggressive HO parameters considerably increase the rate of HOs, i.e., the number of ping-pongs. Although time-of-outage decreases with more aggressive settings, but not so clearly due to increased number of handovers.

In contrast to the above-described conventional HST FR2 communications scheme in which a failure rate during HO or beam-switching may be high, improved techniques of operating a network include enabling switching between two (or more) mobility settings and optimize those depending on network configuration or UE conditions.
One setting (Setting 1-1) can be optimized for non-edge areas or wide areas where several candidate target RRHs/cells and/or beams may be available. Hence, in this case the settings will ensure that unnecessary ping pongs causing connection interruptions can be avoided.
Another setting (Setting 1-2) is used when the UE is moving in an edge area so that the serving beam/cell signal strength might drop quickly while target become stronger than serving. The parameters can be optimized in such a way that the HO or TCI state switch to a target beam and/or RRH/cell happens early enough, i.e., before the signal of the serving cell/beam has degraded too much.

Different mobility setting can be based on the serving beam. Hence, if the UE is in the serving beam coverage which is not close to the coverage edge one setting is used (Setting 1-1) while if the UE is in the edge beam coverage and thereby served by the beam area close to the RRH/cell edge, more aggressive mobility settings are used (Setting 1-2).

In this improvement, it is proposed how and when to configure, optimize mobility settings and switch in between those.

By mobility setting we understand any parameter or any set of HO or beam switching parameters, such as time-to-trigger, hysteresis/offset, events, conditions etc. Mobility settings can be also different in the measurement quantities (e.g., RSRQ, RSRP, SINR) or the periodicity of measurement reports or other related parameters.

The improved techniques of switching between cells or beams ensure that unnecessary ping pongs causing connection interruptions can be avoided and before a signal of a serving cell/beam has degraded too much.

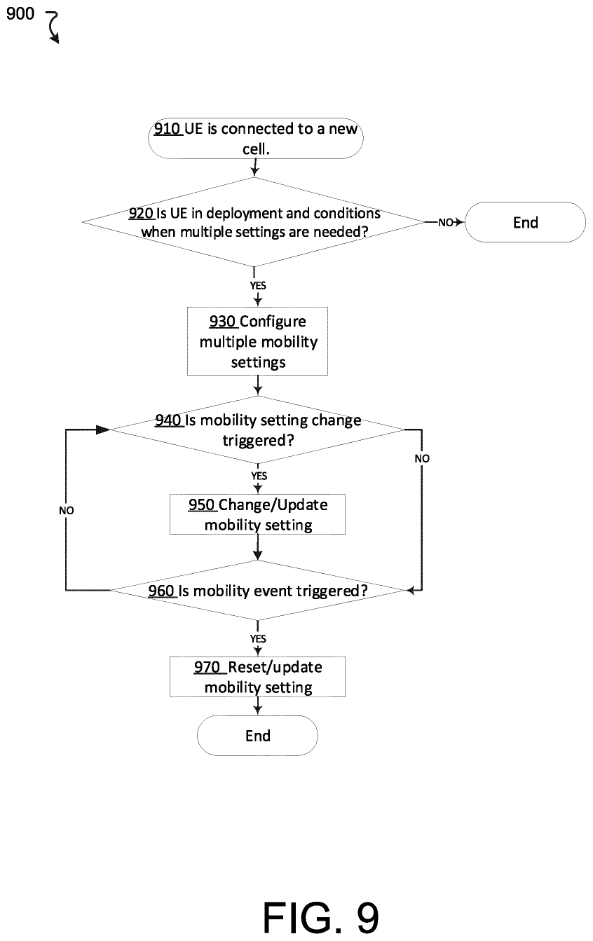

FIG. 9 is a flow chart illustrating an improved process 900 of handling mobility settings. FIG. 9 illustrates a case in which the UE is able to use only one panel at a time. However, the improvement can be extended on the UE capable of receiving and transmitting with multiple panels simultaneously.

At 910, the process starts when the UE connects to a new cell, e.g., with connection establishment procedure or after a HO from the previous cell.

At 920, it is determined whether the deployment and current conditions imply the use of several mobility settings. The conditions can depend on the deployment and also on UE mobility type, direction of movement, location, etc. In HST FR2 scenario, multiple mobility settings will be beneficial e.g., when the UE moves towards the serving beam, and the RRHs are close enough the railway track. For example, the configurations of the following flags can be checked.
a. used on UE side, and highSpeedDeploymentTypeFR2-r17 is unidirectional. Then, NW detects the travelling direction of the UE, e.g., using the sequence of the previous RRHs, or beam changes. When the direction is “opposite”, multiple mobility settings are configured.
b. highSpeedMeasFlagFR2-r17 is Set1 but highSpeedDeploymentTypeFR2-r17 is bi-directional. In this case, at least two mobility settings shall be always configured, because for each RRH the UE is moving at some point towards the serving beam (see FIG. 6).
c. The movement direction of the UE in relation to the serving beam (i.e. towards it or from it) is an additional condition to be checked in HST deployments.

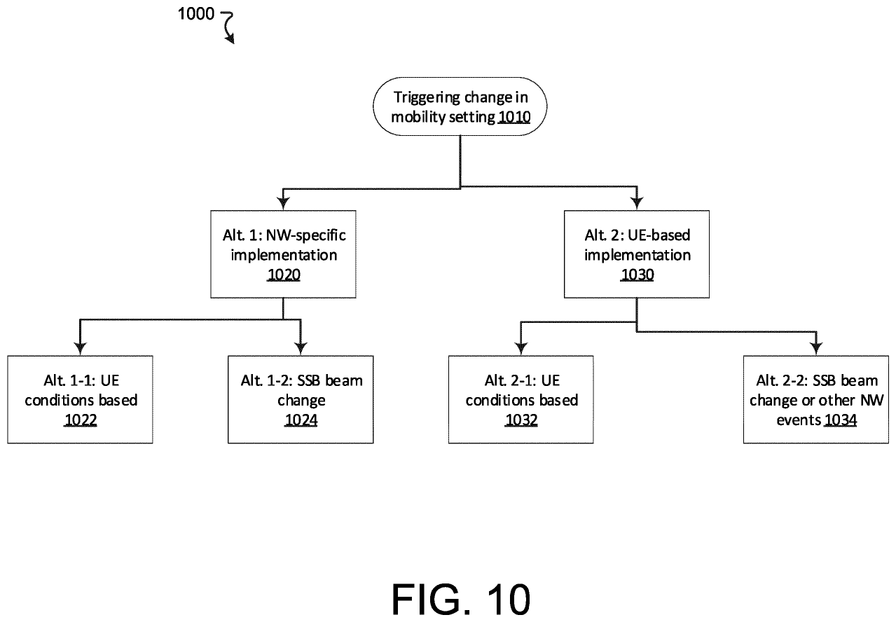

If YES, then at 930, such multiple mobility settings are configured. Several alternative ways to configure multiple mobility settings can be envisioned (see also FIG. 10).
a. Alt. 1: Different mobility settings are configured at the NW side, i.e., network-specific implementation. For example,
   i. Alt. 1-1: Two set of HO/beam switching parameters are configured on the NW side, and the UE does not need to be aware of those. The downside of this approach is that the UE still needs to report all L1 or L3 measurements and NW need to send HO command that will introduce additional latency, i.e., delay the beam/RRH switch and bring UE to the low-SINR area.
   ii. Alt. 1-2: Different mobility settings are configured for different TX beams/TCI states in the cell.
b. Alt. 2: Mobility settings are configured at the UE.
   i. For example, the default mobility setting can be based on conventional NW-controlled HO, whereas the other (more aggressive) setting is provided to the UE with RRC signaling, e.g., using Conditional HO (CHO) configuration.
   ii. In general, multiple CHO configurations can be provided to the UE with RRC signaling (connection reconfiguration), at cell change or initial connection establishment.

At 940, it is determined whether a mobility setting change condition is triggered either in the NW or in the UE depending on the implementation. Even though multiple mobility settings can be configured, it should be indicated/decided which one of them is active. Several triggers to switch in between the mobility settings are possible (see also FIG. 10):
a. Alt. 1-1: For the NW-based implementation, the decision can be based on NW information/state, and/or NW measurements of UE state and/or UE reporting.
   i. NW measurements can include FO, UL receiving signal strength, distance in between RRH and UE, etc. and combinations of those.
      1. Threshold can be defined for the monitored parameters, e.g., for RSRP, change/derivative in RSRP, etc.
      2. UE reporting can include location or the distance to the RRH. For example, the mobility setting change is triggered when the UE gets closer to the RRH than a certain distance, e.g., 100 m.
b. In another NW-based alternative Alt. 1-2, the mobility parameters are different for Tx beams/TCI states. For example, when RRH has several transmit (Tx) beams, and UE switches to the last beam at the edge coverage area of the cell/RRHs along the railways track more aggressive mobility settings can be activated.
c. The mobility setting can be changed at the UE as well (Alt. 2). The possible triggers are as follows.
   i. In Alt. 2-1, UE internal triggers based on measurements, distance to the serving RRH, signal strength, propagation dlay (PD), etc. similarly to Alt. 1-1 can be used.
   ii. In Alt. 2-2, the TCI state/SSB beam switch can be used as a trigger for the change of mobility setting.

If YES, then at 950 change of mobility setting is performed. Change in between mobility settings happens if a corresponding condition was triggered at 940.

At 960, it is determined whether a mobility event (e.g., HO or beam-switch) according to the mobility setting has been triggered. Mobility event can happen, e.g., the UE executes a HO/CHO or TCI state switch. Steps 940-960 are looped, i.e., conditions in 950 and 960 are checked periodically.

If YES, then afterward at 970, the mobility settings can be updated, reconfigured, or returned to the default parameters. After the mobility event, either the original/default mobility setting is activated again or a new setting is configured (e.g., with RRC configuration after HO).
a. Alternatively, some additional conditions are checked before the reset, e.g., that the TCI state belongs to the same/co-located RRH or not.

The change of mobility settings in 940 (FIG. 9) can be implemented in several alternative ways demonstrated in FIG. 10.

FIG. 10 is a flow chart illustrating different alternatives for triggering conditions in between different mobility settings 1000. First, different mobility settings can be configured at the network side only (like in Alternative 1 1020) and/or at the UE (Alternative 2 1030). Further on, change of mobility setting can be triggered either by UE conditions (Alt. 1-1 1022 and 2-1 1032) or by other events such as beam change, etc. (Alt. 1-2 1024, 2-2 1034). In the most general case, Alt. 1. and Alt. 2 are not mutually exclusive since mobility setting can cover both NW-specific (e.g., HO parameters) and UE-specific (e.g., periodicity of measurements reporting) parameters.

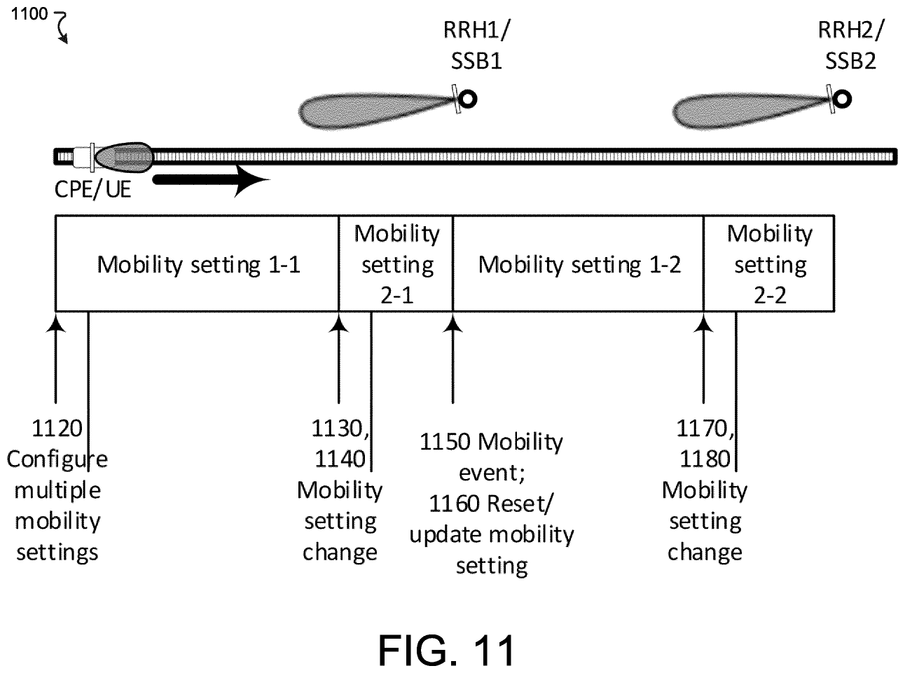

In the HST scenario, the 930-970 from FIG. 9 are demonstrated in FIG. 11. FIG. 11 is a diagram illustrating multiple mobility settings configured in a high-speed train, high-frequency (FR2) scenario. In FIG. 11, the UE is moving in the direction opposite to the serving beam. Initially it follows one mobility Setting (1-1) when it is far away from the RRH location (hence, UE is not at the coverage edge, and moving towards the RRH. The setting set is changed (1140) to another Setting (1-2) once the UE enters the edge area of the serving beam and in this case next to the serving RRH. Then, the beam is changed (at 1150). After that the beam change (and RRH change), the mobility applied setting set is either resettled back to the default Setting (1-1, non-edge area set) or to a new Setting (1-2, another non-edge area set) (1160).

In the most generic case, mobility Settings (1-1) and (1-2) can be different. The same is true for mobility Settings (1-2) and (2-2). The same approach can be also applied in bi-directional HST deployments.

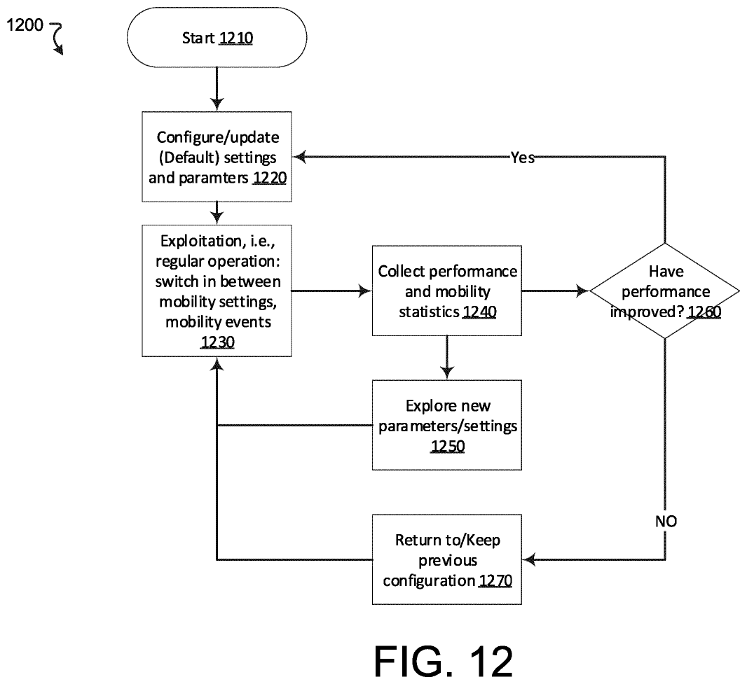

The parameters of each of mobility setting, and mobility setting triggering conditions can be configured in a very flexible way, e.g., in a cell, RRH or even beam-specific way. Therefore, there is room for data-driven optimization of those. One way to achieve that is to use online/reinforcement-based Machine Learning (ML) approach that combines exploration (i.e., trying the new values of the parameters) and exploitation (utilization of selected parameters) of those. An example of such algorithm is shown in FIG. 12.

FIG. 12 is a flow chart illustrating a mobility setting and parameter optimization algorithm 1200. At 1210 and 1220, default values of parameters are selected, and the performance statistics (frequency of mobility event, faults in mobility, connection breaks, throughput, SINR, etc.) are collected at 1230 and 1240. Then, when sufficient statistics are collected, the values of the parameters are changed (either following certain algorithm, logics, or randomly) at 1250. After that, the performance and mobility statics are collected again at 1230 and 1240, and it is determined whether any improvement in those is observed at 1260. If not, then previous configurations are brought back at 1270.

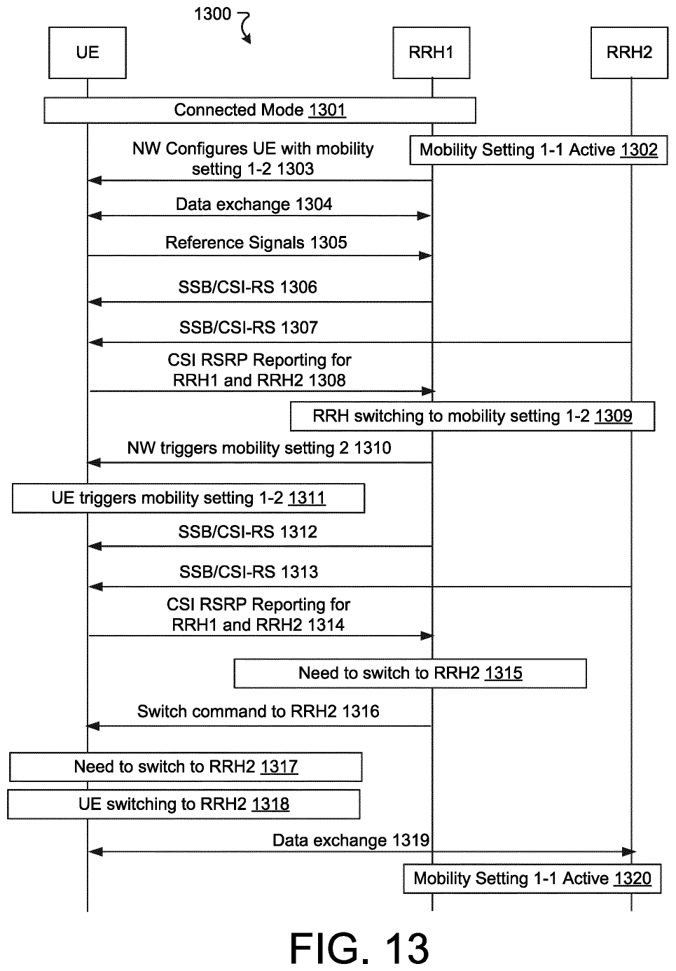

FIG. 13 is a sequence diagram 1300 illustrating a scenario with two mobility settings. In FIG. 13, one possible example of the sequence diagram 1300 corresponding to the general idea description from FIGS. 9, 10, and 11 is presented. In this example, two main alternatives are demonstrated: Alt. 1 and Alt 2.
In Alt. 1, two mobility settings (HO settings) are configured on the network side. The change in between the mobility settings 1-1 and 1-2 happens on the network side as well and takes UE RSRP reporting into account (Alt. 1-1).
In Alt. 2, mobility setting 1-2 is configured at the UE, when the UE connects to the RRH1. Then, activation of a new mobility setting 1-2 happens based on the UE conditions in Step 1311.

At 1301, the UE is in connected mode with RRH1.

At 1302, mobility setting 1-1 is active.

At 1303, RRH1 configures (via the network) the UE with mobility setting 1-2.

At 1304, there is an exchange of data between the UE and RRH1.

At 1305-1308, there is CSI RSRP measurement reporting for both RRH1 and RRH2.

At 1309, based on the measurement reporting, RRH1 and RRTH2 switch to mobility setting 1-2.

At 1310, the network triggers mobility setting 1-2; at 1311, the UE triggers the change to mobility setting 1-2.

At 1312-1314, there is CSI RSRP measurement reporting for both RRH1 and RRH2.

At 1315, it is determined that there is a mobility event: a HO to RRH2.

At 1316, RRH1 sends a HO command to the UE. At 1317-1318, the UE effects the switch to RRH2.

At 1319, the UE and RRH2 exchange data.

At 1320, mobility setting 1-1 is active again.

Using two mobility settings enhances mobility robustness; this is demonstrated through system-level simulations.

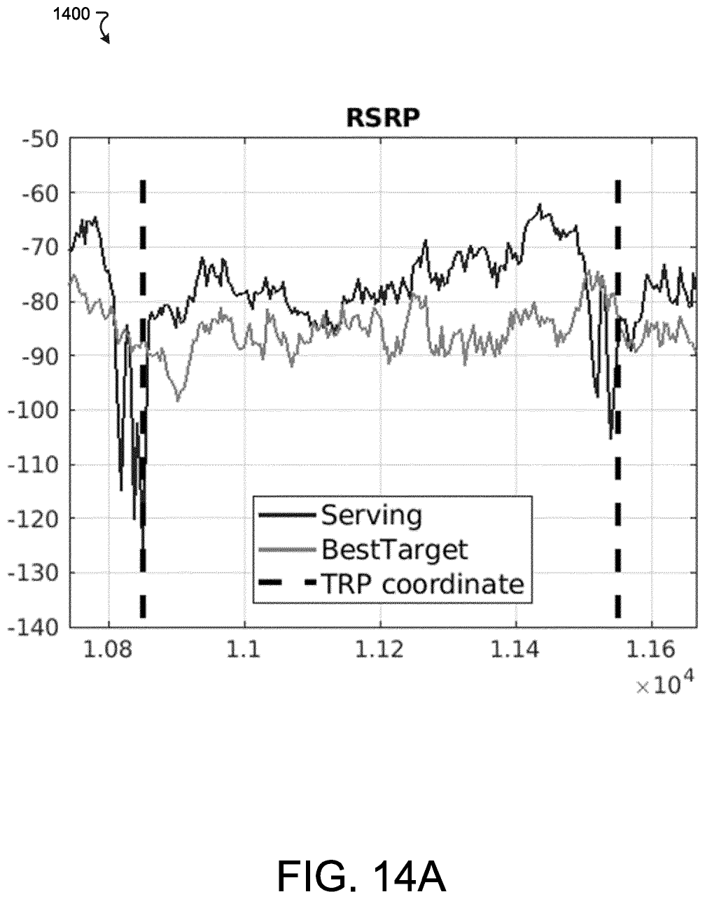

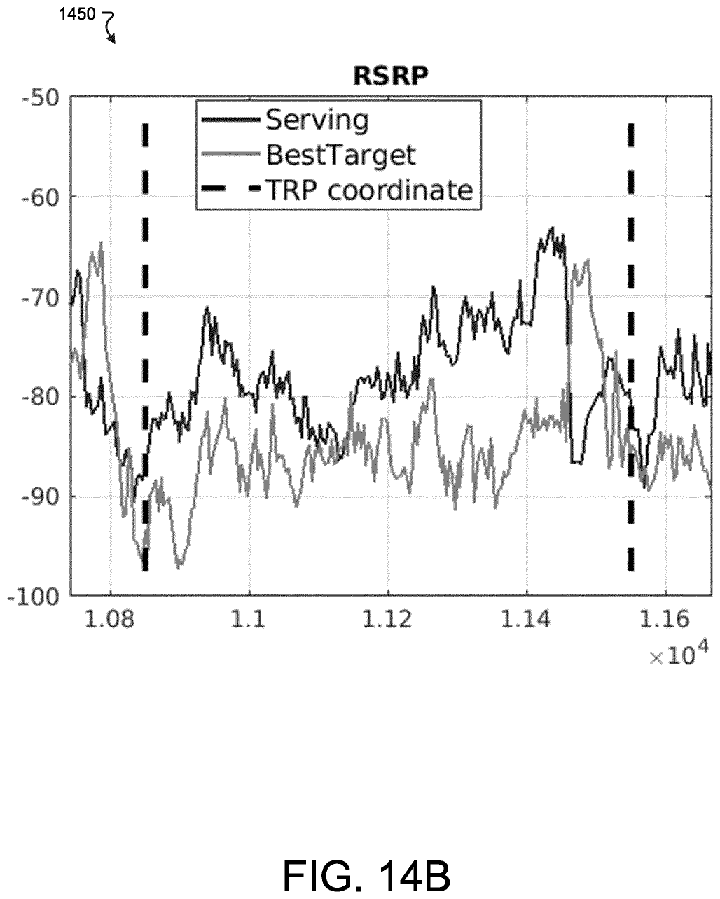

FIG. 14A is a plot 1400 of RSRP traces of serving and best target beams for a default mobility setting, with RRH location shown. FIG. 14B is a plot 1450 of RSRP traces of serving and best target beams for two mobility settings, with RRH location shown. Here, two RSRP time traces are demonstrated for the Scenario-A where the train is travelling in the opposite direction to the serving beam (deployment from Error! Reference source not found). FIG. 14A is the trace with default HO settings and FIG. 14B is the trace when two settings are configured, with more aggressive HO settings (Setting 1-2) next to the RRH. More aggressive settings are triggered when the UE is 100 m to the RRH. It can be seen that significant drops in the signal strength next to the RRH are avoided in FIG. 14B.

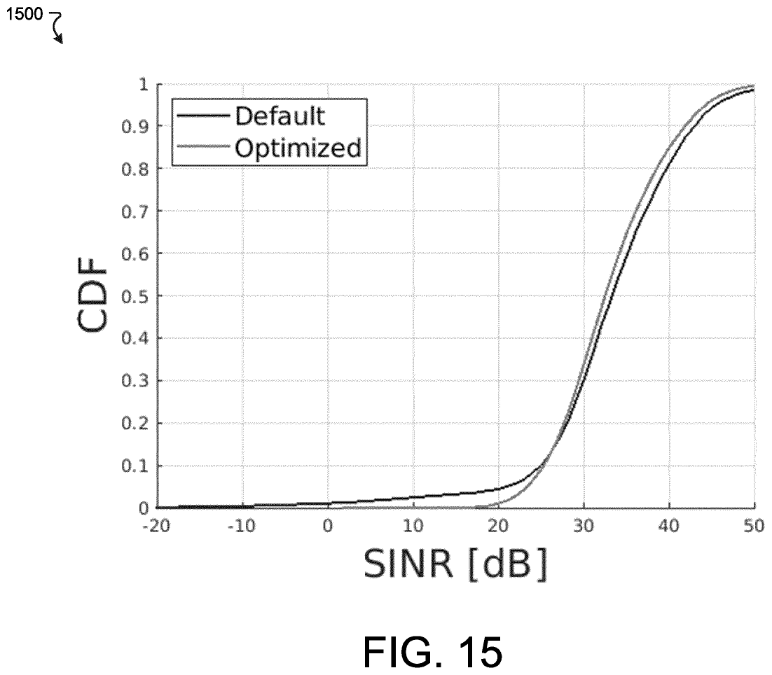

FIG. 15 is a plot 1500 illustrating SINR CDFs collected from a high-speed train, high-frequency (FR2) scenario for default implementation with one mobility setting and for an optimized case with two mobility settings. The observation from FIGS. 14A and 14B is also confirmed in the SINR Cumulative Distribution Function (CDF) collected from multiple simulation runs. The proposed enhanced approach provides significant gain in the lower percentile SINR region.

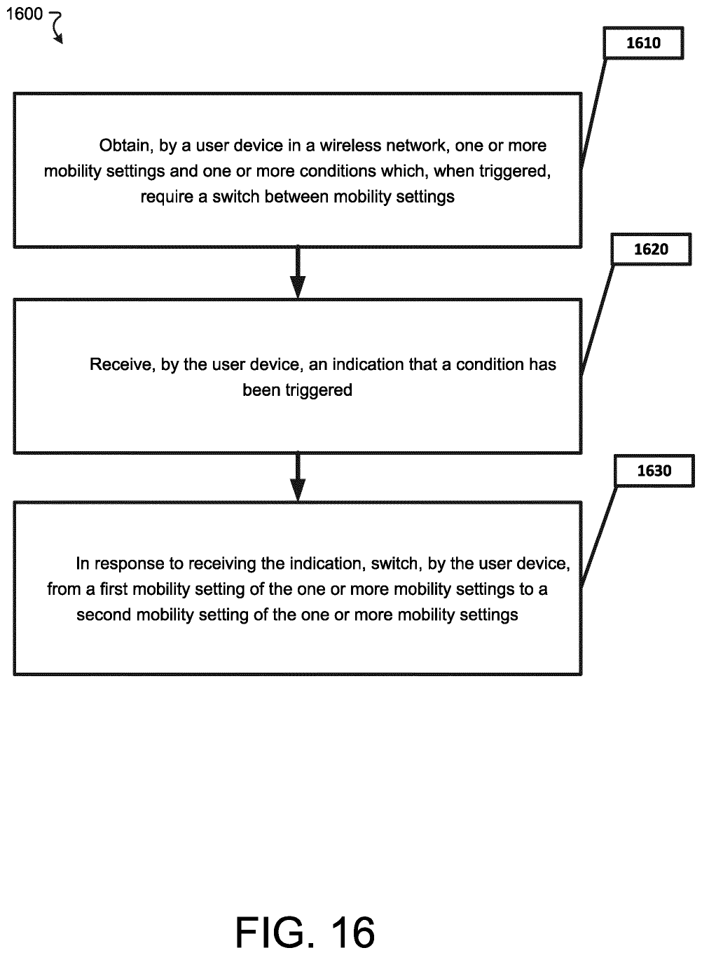

Example 1-1: FIG. 16 is a flow chart illustrating a process 1600 of operating a network with multiple mobility settings. Operation 1610 includes obtaining, by a user device in a wireless network, one or more mobility settings and one or more conditions which, when triggered, require a switch between mobility settings. Operation 1620 includes receiving, by the user device, an indication that a condition has been triggered. Operation 1630 includes, in response to receiving the indication, switching, by the user device, from a first mobility setting of the one or more mobility settings to a second mobility setting of the one or more mobility settings.

Example 1-2: According to an example implementation of example 1-1, further including connecting to a serving beam within a serving cell of a first transmit/reception point, the user device being in the first mobility setting; and determining that a criterion indicating a requirement for multiple mobility settings exists, wherein the plurality of mobility settings and the set of conditions are obtained in response to the determining that the condition exists.

Example 1-3: According to an example implementation of example 1-2, wherein the first transmit/reception point includes a first remote radio head.

Example 1-4: According to an example implementation of example 1-3, wherein the criterion defining the mobility setting change includes a distance from the pathway or user equipment to the first remote radio head being less than a threshold.

Example 1-5: According to an example implementation of examples 1-3 or 1-4, wherein the criterion defining the mobility setting change includes a direction of motion of the user device being opposite with respect to the serving beam of the first remote radio head.

Example 1-6: According to an example implementation of examples 1-3 to 1-6, wherein the criterion defining the mobility setting change includes a deployment type for the first remote radio head being bidirectional.

Example 1-7: According to an example implementation of examples 1-3 to 1-6, wherein obtaining the plurality of mobility settings and the set of conditions includes obtaining L1 reference signal receive power beam measurements; and performing a handover process from the serving cell to a target cell based on the L1 reference signal receive power beam measurements.

Example 1-8: According to an example implementation of examples 1-3 to 1-7, wherein obtaining the plurality of mobility settings and the set of conditions includes obtaining L3 reference signal receive power beam measurements; and performing a beam switching process from the serving beam to a target beam within the serving cell based on the L3 reference signal receive power beam measurements.

Example 1-9: According to an example implementation of examples 1-3 to 1-8, wherein obtaining the plurality of mobility settings and the set of conditions includes receiving, via a radio resource control signal, a conditional handover configuration; and performing a handover process from the serving cell to a target cell based on the conditional handover configuration.

Example 1-10: According to an example implementation of examples 1-3 to 1-9, wherein a condition includes a distance to the first remote radio head being less than a threshold.

Example 1-11: According to an example implementation of examples 1-3 to 1-10, wherein a condition includes a downlink signal strength being less than a threshold.

Example 1-12: According to an example implementation of examples 1-3 to 1-11, wherein a condition includes a propagation delay being greater than a threshold.

Example 1-13: According to an example implementation of examples 1-1 to 1-12, wherein obtaining the plurality of mobility settings and the set of conditions includes for each of the plurality of mobility settings, performing an optimization of parameter values defining that mobility setting.

Example 1-14: According to an example implementation of example 1-13, wherein performing the optimization of parameter values defining each of the plurality of mobility settings includes collecting parameter values after switching from the first mobility setting to the second mobility setting; inputting the parameter values into a performance metric to produce a new performance value; and comparing the performance value to a previous performance value.

Example 1-15: An apparatus comprising means for performing a method of any of examples 1-1 to 1-14.

Example 1-16: A computer program product including a non-transitory computer-readable storage medium and storing executable code that, when executed by at least one data processing apparatus, is configured to cause the at least one data processing apparatus to perform a method of any of examples 1-1 to 1-14.

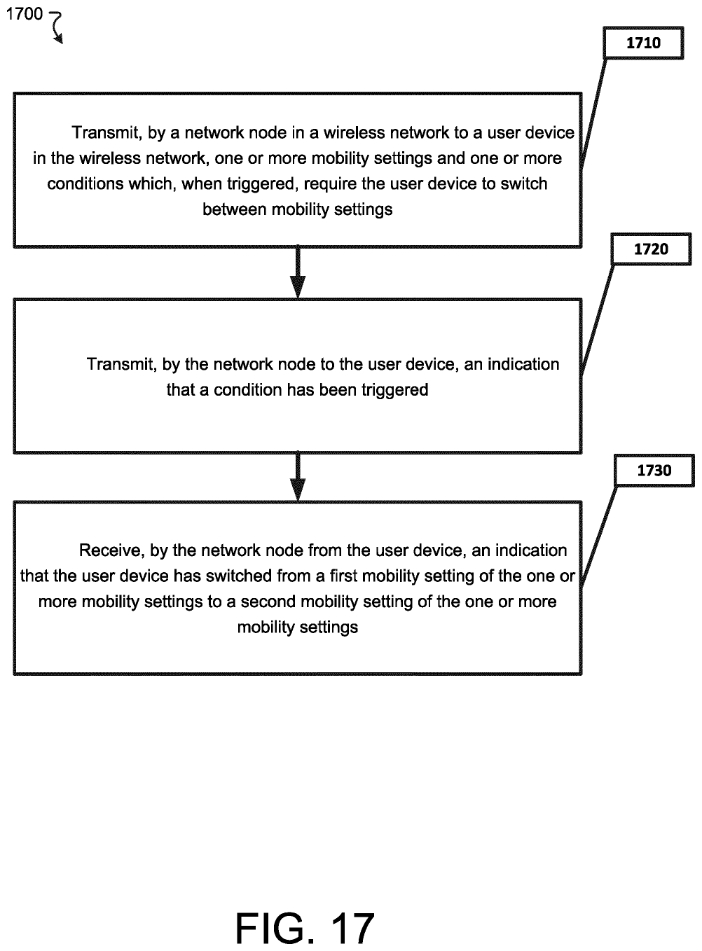

Example 2-1: FIG. 17 is a flow chart illustrating a process 1700 of operating a network with multiple mobility settings. Operation 1710 includes transmitting, by a network node in a wireless network to a user device in the wireless network, one or more mobility settings and one or more conditions which, when triggered, require the user device to switch between mobility settings. Operation 1720 includes transmitting, by the network node to the user device, an indication that a condition has been triggered. Operation 1730 includes receiving, by the network node from the user device, an indication that the user device has switched from a first mobility setting of the one or more mobility settings to a second mobility setting of the one or more mobility settings.

Example 2-2: According to an example implementation of example 2-1, wherein the method further includes generating the plurality of mobility settings, each of the plurality of mobility settings corresponding to a respective cell of a plurality of cells.

Example 2-3: According to an example implementation of example 2-2, wherein each of the plurality of transmit/reception points includes a respective remote radio head.

Example 2-4: According to an example implementation of examples 2-2 or 2-3, wherein the method further includes generating the plurality of mobility settings, each of the one or more mobility settings corresponding to a respective remote radio head of a plurality of remote radio heads.

Example 2-5: According to an example implementation of examples 2-1 to 2-4, wherein the method further includes generating the plurality of mobility settings, each of the plurality of mobility settings corresponding to a respective beam of a plurality of beams within a cell of a plurality of cells.

Example 2-6: According to an example implementation of examples 2-1 to 2-5, wherein the method further includes causing the user device to connect to a serving beam within a serving cell of a first remote radio head, the user device being in the first mobility setting; and determining that a criterion indicating a requirement for multiple mobility settings exists, wherein the plurality of mobility settings and the set of conditions are obtained in response to the determining that the condition exists.

Example 2-7: According to an example implementation of examples 2-1 to 2-6, wherein the criterion defining the mobility setting change includes a distance from a pathway or the user equipment to the first remote radio head being less than a threshold.

Example 2-8: According to an example implementation of examples 2-1 to 2-7, wherein the criterion defining the mobility setting change includes a direction of motion of the user device being opposite with respect to the serving beam of the first remote radio head.

Example 2-9: According to an example implementation of examples 2-1 to 2-8, wherein the criterion defining the mobility setting change includes a deployment type for the first remote radio head being bidirectional.

Example 2-10: According to an example implementation of examples 2-1 to 2-9, further comprising receiving L1 reference signal receive power beam measurements from the user device; and performing a handover process from the serving cell to a target cell based on the L1 reference signal receive power beam measurements.

Example 2-11: According to an example implementation of examples 2-1 to 2-10, further comprising receiving L3 reference signal receive power beam measurements from the user device; and performing a beam switching process from the serving beam to a target beam within the serving cell based on the L3 reference signal receive power beam measurements.

Example 2-12: According to an example implementation of examples 2-1 to 2-11, wherein obtaining the plurality of mobility settings and the set of conditions includes transmitting, via a radio resource control signal to the user device, a conditional handover configuration; and performing a handover process from the serving cell to a target cell based on the conditional handover configuration.

Example 2-13: According to an example implementation of examples 2-1 to 2-12, wherein a condition includes a distance to the first remote radio head being less than a threshold.

Example 2-14: According to an example implementation of examples 2-1 to 2-13, wherein a condition includes a downlink signal strength being less than a threshold.

Example 2-15: According to an example implementation of examples 2-1 to 2-14, wherein a condition includes a propagation delay being greater than a threshold.

Example 2-16: An apparatus comprising means for performing a method of examples 2-1 to 2-15.

Example 2-17: A computer program product including a non-transitory computer-readable storage medium and storing executable code that, when executed by at least one data processing apparatus, is configured to cause the at least one data processing apparatus to perform a method of examples 2-1 to 2-15.

### List of Example Abbreviations

| | |
|---|---|
| AP | Access Point |
| AtG | Air-To-Ground |
| CHO | Conditional Handover |
| CDF | Cumulative Distribution Function |
| DL | Downlink |
| DPS | Dynamic Point Selection |
| DRX | Discontinuous Reception |
| DU | Distributed Unit |
| FO | Frequency Offset |
| FR2 | Frequency Range 2 (above 6 GHz) |
| gNB | next Generation Node B |
| HO | Handover |
| HST | High Speed Train |
| L1 | Layer 1 |
| L3 | Layer 3 |
| ML | Machine Learning |
| MAC | Medium Access Control |
| MPU | Multiple Panel UE |
| NR | New Radio |
| NW | Network |
| PD | Propagation Delay |
| PDCCH | Physical Downlink Control Channel |
| RSRP | Reference Signal Received Power |
| RLF | Radio Link Failure |
| RRH | Remote Radio Head |
| RRM | Radio Resource Management |
| Rx | Receive |
| SINR | Signal to Interference and Noise Ratio |
| SNR | Signal to Noise Ratio |
| SSB | Synchronization Signal/PBCH (Physical Broadcast |
| | Channel) block |
| TA | Timing Advance (in UL) |
| TCI | Transmission Configuration Indicator |
| TRP | Transmission-Reception Point |
| TO | Time Offset |
| Tx | Transmit |
| TTT | Time To Trigger |
| UE | User Equipment |
| UL | Uplink |
| WI | Work Item |

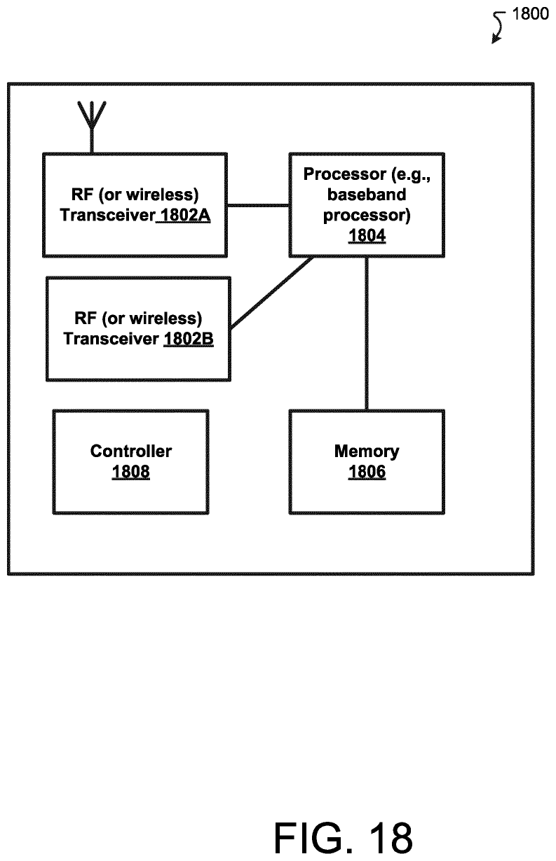

FIG. 18 is a block diagram of a wireless station (e.g., AP, BS, e/gNB, NB-IoT UE, UE or user device) 1800 according to an example implementation. The wireless station 1800 may include, for example, one or multiple RF (radio frequency) or wireless transceivers 1802A, 1802B, where each wireless transceiver includes a transmitter to transmit signals (or data) and a receiver to receive signals (or data). The wireless station also includes a processor or control unit/entity (controller) 1804 to execute instructions or software and control transmission and receptions of signals, and a memory 1806 to store data and/or instructions.

Processor 1804 may also make decisions or determinations, generate slots, subframes, packets or messages for transmission, decode received slots, subframes, packets or messages for further processing, and other tasks or functions described herein. Processor 1804, which may be a baseband processor, for example, may generate messages, packets, frames or other signals for transmission via wireless transceiver 1802 (1802A or 1802B). Processor 1804 may control transmission of signals or messages over a wireless network, and may control the reception of signals or messages, etc., via a wireless network (e.g., after being down-converted by wireless transceiver 1802, for example). Processor 1804 may be programmable and capable of executing software or other instructions stored in memory or on other computer media to perform the various tasks and functions described above, such as one or more of the tasks or methods described above. Processor 1804 may be (or may include), for example, hardware, programmable logic, a programmable processor that executes software or firmware, and/or any combination of these. Using other terminology, processor 1804 and transceiver 1802 (1802A or 1802B) together may be considered as a wireless transmitter/receiver system, for example.

In addition, referring to FIG. 18, a controller (or processor) 1808 may execute software and instructions, and may provide overall control for the station 1800, and may provide control for other systems not shown in FIG. 18 such as controlling input/output devices (e.g., display, keypad), and/or may execute software for one or more applications that may be provided on wireless station 1800, such as, for example, an email program, audio/video applications, a word processor, a Voice over IP application, or other application or software.

In addition, a storage medium may be provided that includes stored instructions, which when executed by a controller or processor may result in the processor 1904, or other controller or processor, performing one or more of the functions or tasks described above.

According to another example implementation, RF or wireless transceiver(s) 1902A/1902B may receive signals or data and/or transmit or send signals or data. Processor 1904 (and possibly transceivers 1902A/1902B) may control the RF or wireless transceiver 1902A or 1902B to receive, send, broadcast or transmit signals or data.

The embodiments are not, however, restricted to the system that is given as an example, but a person skilled in the art may apply the solution to other communication systems. Another example of a suitable communications system is the 5G concept. It is assumed that network architecture in 5G will be quite similar to that of the LTE-advanced. 5G uses multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (IoT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, implementations of the various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall as intended in the various embodiments.

1.-60. (canceled)

61. An apparatus, comprising:
at least one processor; and
at least one memory including computer program code;
the at least one memory and the computer program code configured to cause the apparatus at least to:
obtain, by a user device in a wireless network, one or more mobility settings and one or more conditions which, when triggered, require a switch between mobility settings;
receive, by the user device, an indication that a condition has been triggered; and
in response to receiving the indication, switch, by the user device, from a first mobility setting of the one or more mobility settings to a second mobility setting of the one or more mobility settings.

62. The apparatus as in claim 61, wherein the at least one memory and the computer program code is further configured to cause the apparatus at least to:
connect to a serving beam within a serving cell of a first transmit/reception point, the user device being in the first mobility setting; and
determine that a criterion indicating a requirement for multiple mobility settings exists,
wherein the plurality of mobility settings and the set of conditions are obtained in response to the determining that the condition exists.

63. The apparatus as in claim 62, wherein the first transmit/reception point includes a first remote radio head.

64. The apparatus as in claim 63, wherein the criterion defining the mobility setting change includes a distance from a pathway or a user equipment to the first remote radio head being less than a threshold.

65. The apparatus as in claim 63, wherein the criterion defining the mobility setting change includes a direction of motion of the user device being opposite with respect to the serving beam of the first remote radio head.

66. The apparatus as in claim 63, wherein the criterion defining the mobility setting change includes a deployment type for the first remote radio head being bidirectional.

67. The apparatus as in claim 63, wherein the at least one memory and the computer program code configured to obtain the plurality of mobility settings and the set of conditions is further configured to cause the apparatus at least to:
obtain L1 reference signal receive power beam measurements; and
perform a handover process from the serving cell to a target cell based on the L1 reference signal receive power beam measurements.

68. The apparatus as in claim 63, wherein the at least one memory and the computer program code configured to obtain the plurality of mobility settings and the set of conditions is further configured to cause the apparatus at least to:
obtain L3 reference signal receive power beam measurements; and
perform a beam switching process from the serving beam to a target beam within the serving cell based on the L3 reference signal receive power beam measurements.

69. The apparatus as in claim 63, wherein the at least one memory and the computer program code configured to obtain the plurality of mobility settings and the set of conditions is further configured to cause the apparatus at least to:
receive, via a radio resource control signal, a conditional handover configuration; and
perform a handover process from the serving cell to a target cell based on the conditional handover configuration.

70. The apparatus as in claim 63, wherein a condition of the set of conditions includes a distance to the first remote radio head being less than a threshold.

71. The apparatus as in claim 63, wherein a condition of the set of conditions includes a downlink signal strength being less than a threshold.

72. The apparatus as in claim 63, wherein a condition of the set of conditions includes a propagation delay being greater than a threshold.

73. The apparatus as in claim 61, wherein the at least one memory and the computer program code configured to obtain the plurality of mobility settings and the set of conditions is further configured to cause the apparatus at least to:
for each of the plurality of mobility settings, perform an optimization of parameter values defining that mobility setting.

74. The apparatus as in claim 73, wherein the at least one memory and the computer program code configured to perform the optimization of parameter values defining each of the plurality of mobility settings is further configured to cause the apparatus at least to:
collect parameter values after switching from the first mobility setting to the second mobility setting;
input the parameter values into a performance metric to produce a previously presented performance value; and
compare the performance value to a previous performance value.

75. A method, comprising:
obtaining, by a user device in a wireless network, one or more mobility settings and one or more conditions which, when triggered, require a switch between mobility settings;
receiving, by the user device, an indication that a condition has been triggered; and
in response to receiving the indication, switching, by the user device, from a first mobility setting of the one or more mobility settings to a second mobility setting of the one or more mobility settings.

76. The method as in claim 75, further comprising:
connecting to a serving beam within a serving cell of a first transmit/reception point, the user device being in the first mobility setting; and
determining that a criterion indicating a requirement for multiple mobility settings exists,
wherein the plurality of mobility settings and the set of conditions are obtained in response to the determining that the condition exists.

77. The method as in claim 76, wherein the first transmit/reception point includes a first remote radio head.

78. The method as in claim 77, wherein at least one of:
the criterion defining the mobility setting change includes a distance from the pathway or user equipment to the first remote radio head being less than a threshold; or
the criterion defining the mobility setting change includes a direction of motion of the user device being opposite with respect to the serving beam of the first remote radio head; or
the criterion defining the mobility setting change includes a deployment type for the first remote radio head being bidirectional; or
obtaining the plurality of mobility settings and the set of conditions includes:
obtaining L1 reference signal receive power beam measurements; and
performing a handover process from the serving cell to a target cell based on the L1 reference signal receive power beam measurements; or
obtaining the plurality of mobility settings and the set of conditions includes:
obtaining L3 reference signal receive power beam measurements; and
performing a beam switching process from the serving beam to a target beam within the serving cell based on the L3 reference signal receive power beam measurements; or
obtaining the plurality of mobility settings and the set of conditions includes:
receiving, via a radio resource control signal, a conditional handover configuration; and
performing a handover process from the serving cell to a target cell based on the conditional handover configuration; or
a condition includes a distance to the first remote radio head being less than a threshold; or
a condition includes a downlink signal strength being less than a threshold; or
a condition includes a propagation delay being greater than a threshold.

79. The method as in claim 75, wherein obtaining the plurality of mobility settings and the set of conditions includes:
for each of the plurality of mobility settings, performing an optimization of parameter values defining that mobility setting.

80. An apparatus comprising means for performing a method according to claim 75.
